(19) United States
(12) Patent Application Publication
(10) Pub. No.: US 2022/0065626 A1
(43) Pub. Date: Mar. 3, 2022

(54) LASER DEMARCATION APPARATUS WITH ANGLE DETECTION FUNCTION

(71) Applicant: ZHUHAI LEVELSURE TECHNOLOGY CO.,LTD., Zhuhai City (CN)

(72) Inventors: Xiaojuan Li, Weinan City (CN); Jiang Yu, Zhuhai City (CN)

(21) Appl. No.: 17/034,127

(22) Filed: Sep. 28, 2020

(30) Foreign Application Priority Data
Sep. 3, 2020 (CN) 202010917467.8

(51) Int. Cl. G01C 9/12; G01P 15/18; G01B 7/30; G01C 9/02; H04W 4/80

(52) U.S. Cl. CPC G01C 9/12; G01P 15/18; H04W 4/80; G01C 9/02; G01B 7/30

(57) ABSTRACT

The invention provides a laser demarcation apparatus with angle detection function including a main body. The main body is disposed with a pendulum body, and the pendulum body is disposed with a laser module. The main body is further disposed with a motherboard, and the motherboard is disposed with a tilt detection apparatus. The tilt detection apparatus includes an MCU control module, an acceleration sensor, a crystal oscillator module and a power supply module. The MCU control module is used for controlling and analyzing angle tilt information, the acceleration sensor is used for detecting a tilt angle, the crystal oscillator module is used for stabilizing a control frequency of the MCU control module, and the power supply module is used for supplying power. The MCU control module is used for controlling the acceleration sensor and the crystal oscillator module individually.

### TECHNICAL FIELD

The invention relates to the field of laser demarcation apparatuses, and more particularly to a laser demarcation apparatus with an angle detection function.

### DESCRIPTION OF RELATED ART

In a horizontal mode of a conventional laser demarcation apparatus (also referred to laser level), a tilt/inclination detection device generally adopts a structure in which a pendulum body is electrically conductive and transmits a signal to a motherboard chip through a contact of a metal spring with a bottom conductive plate. Such the structure has poor contact and inaccurate detection of tilt angle, or has poor contact even no contact resulting from assembly errors, so that the motherboard chip cannot receive the signal and thus cannot issue an alarm response in time, causing a problem of consumers mistakenly considering as qualified in the process of use because of no alarm when the angle is exceeded, and such problem is needed to be solved.

A Chinese patent application No. 201921047799.4 (patent publication number of which is CN209857872U), filed on Jul. 4, 2019, published on Dec. 27, 2109 and titled as “an inclinometer”, discloses an inclinometer, which includes a shell, an angle measuring module and a laser emitting device for emitting a laser. The angle measuring module is used for measuring an inclination angle of the laser, the angle measuring module and the laser emitting device are both arranged in the shell. A fixing base and a fixing cover snapped with the fixing base are arranged in the shell, and the laser emitting device is arranged between the fixing base and the fixing cover. A locking piece used for fixing the laser emitting device is arranged on the fixing cover. The inclinometer can enable objects to be arranged along a straight line, it is convenient to use and does not leave a trace.

The above-mentioned patent document has disclosed a portable pendulum type automatic leveling laser collimating demarcation apparatus. However, the inclinometer cannot realize intelligent detection and its function is too single, and the detection of inclination angle is not accurate enough to meet the needs of consumers.

### SUMMARY

Accordingly, a primary objective of the invention is to provide a laser demarcation apparatus with angle detection function which may have advantages of being multifunctional, accurate detection of inclination angle and easy to operate.

In order to achieve the above objective, a laser demarcation apparatus with angle detection function according to an embodiment of the invention includes a main body, the main body is disposed with a pendulum body, and the pendulum body is disposed with a laser module. The main body further is disposed with a motherboard, and the motherboard is disposed with a tilt detection device.

The tilt detection device includes a MCU control module, an acceleration sensor, a crystal oscillator module and a power supply module; the MCU control module is configured (i.e., structured and arranged) for controlling and analyzing angle tilt information, the acceleration sensor is configured for detecting a tilt angle to thereby generate the angle tilt information, the crystal oscillator module is configured for stabilizing a control frequency of the MCU control module, and the power supply module is configured for supplying a power.

The MCU control module is configured for controlling the acceleration sensor and the crystal oscillator module individually.

In an embodiment, the MCU control module is connected with a display module, the motherboard is disposed with a display screen, and the display module is configured for controlling the display screen to display.

In an embodiment, the MCU control module is connected with a bluetooth module, and the bluetooth module is configured for transmitting a detection information.

In an embodiment, the MCU control module is connected with a debug module, and the debug module is configured for debugging tilt data.

In an embodiment, the MCU control module is connected with an alarm module, and the alarm module is configured for alarming.

In an embodiment, the power supply module includes a boost charging module, a lithium battery, a first MOS transistor, and a boost power chip; the boost charging module is configured for charging the lithium battery, and the lithium battery is configured for supplying a power to the boost power chip by the first MOS transistor.

In an embodiment, the power supply module further includes a dry battery, and a second MOS transistor; the dry battery is configured for supplying a power to the boost power chip by the second MOS transistor.

In an embodiment, the power supply module further includes a step-down power chip.

The technical solutions as proposed by the embodiments of the invention may have following beneficial effects that:

1) the embodiment of invention uses the MCU control module to control the acceleration sensor to detect the inclination angle, the embodiment of invention sets zero in the horizontal state, and meanwhile can alarm when an uneven working surface exceeds the set angle, the accuracy of the acceleration sensor is as accuracy of the whole apparatus. Moreover, the contact of the pendulum body of the main body is cancelled, which reduces the installation requirements and is stable in use.

2) the main body associated with the embodiment of invention is disposed with the acceleration sensor, by using the acceleration sensor to obtain data and provide the obtained data to the motherboard for processing and feedbacking to the display screen of the main body to display a current angle value, and thereby achieve the purpose of measuring/detecting the angle; and at the same time, it can acquire the required angle position by cooperating with a line projected by the demarcation device onto a target object or wall, there is no need to use an inclinometer to assist. The projected line and angle display both are provided by the main body of the invention, so no auxiliary coordination is required, and the data read by different users are consistent, and it will not cause reading error due to poor cooperation of users.

3) the embodiment of the invention cancels a conductive circuit and a contact plate, reduces the production materials, reduces the installation process, the acceleration sensor is controlled in the process of use by the MCU control module to detect the tilt angle being more sensitive and stable, does not need the complex hardware circuit, and reduces the risk that the circuit cannot work due to circuit damage in high temperature and high humidity environment.

### BRIEF DESCRIPTION OF THE DRAWINGS

In order to more clearly illustrate technical solutions of embodiments of the disclosure, drawings used in the description of the embodiments will be briefly described below. Apparently, the drawings described below are merely some embodiments of the disclosure, and those skilled in the art can obtain other drawings based on these drawings without creative efforts.

FIG. 1 is a schematic disassembled structural view of a laser demarcation apparatus with angle detection function according to an embodiment of the invention.

FIG. 2 is a schematic perspective structural view of a laser demarcation apparatus with angle detection function according to another embodiment of the invention.

FIG. 3 is a schematic system block diagram of a laser demarcation apparatus with angle detection function according to an embodiment of the invention.

FIG. 4 is a schematic block diagram of a power supply module of a laser demarcation apparatus with angle detection function according to an embodiment of the invention.

### DESCRIPTION OF NUMERICAL REFERENCES IN DRAWINGS

| Numerical | | Numerical | |
|---|---|---|---|
| reference | description | reference | description |
| 1 | Main body | 2165 | First MOS transistor |
| 2 | Motherboard | 2166 | Second MOS transistor |
| 3 | Pendulum body | 2167 | Third MOS transistor |
| 4 | Laser module | 2168 | Boost power chip |
| 5 | Display screen | 2169 | Step-down power chip |
| 21 | MCU control module | 2171 | Laser control module |
| 211 | Communication interface | 2172 | Keypad module |
| 212 | Serial port interface | 2173 | Alarm module |
| 213 | Serial communication | 22 | Acceleration sensor |
| | interface | 23 | Display module |
| 214 | Debug interface | 24 | Bluetooth module |
| 215 | Crystal oscillator interface | 25 | SWD debug module |
| 216 | Power supply module | 2151 | Crystal oscillator |
| 217 | Input/output interface | | module |
| 2161 | Dry battery | | |
| 2162 | Lithium battery | | |
| 2163 | USB interface | | |
| 2164 | Boost charging module | | |

The realization of objective, functional features and advantages of the invention will be further described in combination with embodiments with reference to accompanying drawings.

### DETAILED DESCRIPTION OF EMBODIMENTS

The technical solutions in the embodiments of the invention will be clearly and completely described below, with reference to the accompanying drawings in the embodiments of the invention. Apparently, the described embodiments are merely some of the embodiments of the invention, not all embodiments. Based on the described embodiments of the invention, all other embodiments obtained by those skilled in the art without any creativity should belong to the protective scope of the invention.

It is noted that, in the embodiments of the invention, all directional indications (such as “above”, “below”, “left”, “right”, “front”, “rear”, “top”, etc.) are merely for indicating relative positional relationships and motions among various components under certain specific postures (as shown in the drawings), if the specific postures change, the directional indication will change accordingly.

In the description of the invention, unless otherwise clearly stated and limited, terms “connected”, “fixed” and so on should be understood broadly. For instance, “fixed” can be a fixed connection, a detachable connection or an integral connection; can be a mechanical connection, can also be an electrical connection; can be a direct connection, can also be an indirect connection by an intermediary, can be an internal communication of two elements or an interaction between two elements, unless otherwise clearly defined. A person skilled in the art can understand concrete meanings of the terms in the invention as per specific circumstances.

Moreover, terms such as “first” and “second” are merely for the purpose of illustration and cannot be understood as indicating or implying the relative importance or implicitly indicating the number of the technical feature. Therefore, features defined by “first” and “second” can explicitly or implicitly include one or more the features. In the description of the invention. In addition, the technical solutions of various embodiments may be combined together, any combination must be based on the realization of ordinary skilled person in the art. When a combination of technical solutions is contradictory or unable to be realized, it should be considered that such the combination of technical solutions does not exist and is not within the protection scope of the invention.

The invention provides a laser demarcation apparatus with angle detection function.

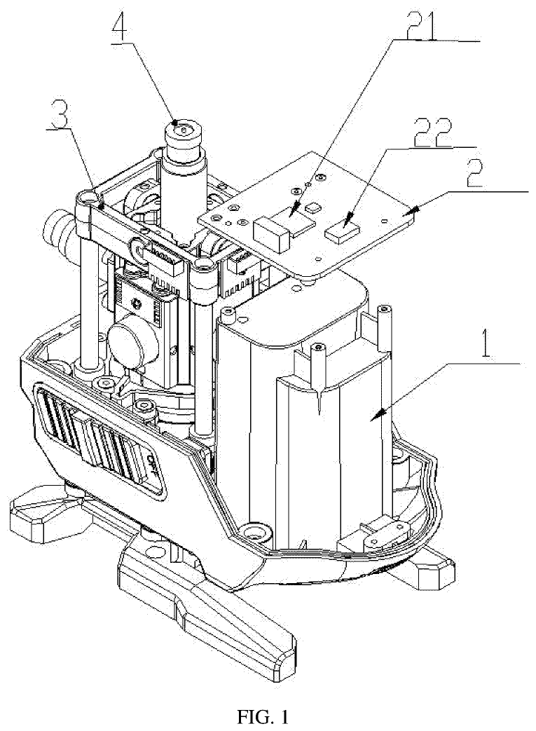

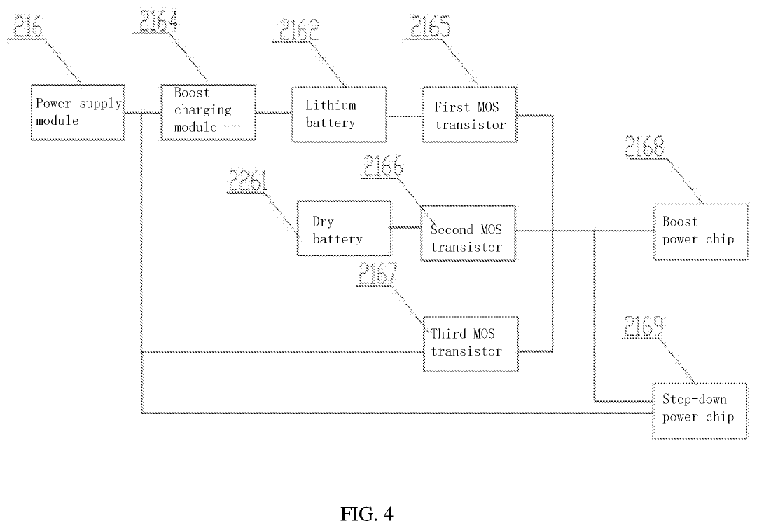

Referring to FIG. 1 through FIG. 4, in an embodiment of the invention, the laser demarcation apparatus with angle detection function includes a main body 1, and the main body 1 is disposed with a pendulum body 3. The pendulum body 3 is disposed with a laser module 4. The main body 1 is further disposed with a motherboard 2, and the motherboard 2 is disposed with a tilt detection device.

The tilt detection device includes an MCU (Microcomputer Unit) control module 21, an acceleration sensor 22, a crystal oscillator module 2151 and a power supply module 216. The MCU control module 21 is configured (i.e., structured and arranged) for controlling and analyzing angle tilt information. The acceleration sensor 22 is configured for detecting a tilt angle. The crystal oscillator module 2151 is for stabilizing a control frequency of the MCU control module 21. The power supply module 216 is configured for providing a power supply.

The MCU control module 21 is configured for controlling the acceleration sensor 22 (a type of angle detection module) and the crystal oscillator module 2151.

In an exemplary embodiment, the MCU control module 21 is an MCU chip with a product number of APM32F103RBT6.

In an exemplary embodiment, the acceleration sensor 22 is an acceleration sensor chip with a product name of SENSOR.

In the illustrated embodiment, the acceleration sensor 22 is mounted onto the motherboard 2 and fixedly integrated with the motherboard 2. The motherboard 2 is fixed onto the main body 1. The pendulum body 3 is a gyroscope pendulum assembly. The gyroscope pendulum assembly may also be fixed with the main body 1, so that the acceleration sensor 22 is parallel to the gyroscope pendulum assembly.

When it is activated by power, the main body 1 is tilted, the acceleration sensor 22 works to pick up angle data, the MCU control module 21 obtains an angle value based on the picked angle data and displays a current angle value on a display screen, as a result, an angle measurement/detection function is achieved.

In addition, the gyroscope pendulum assembly is disposed with a laser module (also referred to laser generator) 4. The laser module 4 may provide a horizontal line. The horizontal line can also be used as a reference for measurement or work, so as to achieve a demarcation function of angle measurement or reference.

The MCU control module 21 obtains a pitch angle of the acceleration sensor 22 through the following formula that:

$$Pitch = α = arctan ( \frac{{A}_{X 1}}{\sqrt{{( {A}_{Y 1} )}^{2} + {( {A}_{Z 1} )}^{2}}} )$$

The MCU control module 21 obtains a roll angle of the acceleration sensor 22 through the following formula that:

$$Roll = β = arctan ( \frac{{A}_{Y 1}}{\sqrt{{( {A}_{X 1} )}^{2} + {( {A}_{Z 1} )}^{2}}} )$$

In the illustrated embodiment, moreover, it is preferred that the MCU control module 21 controls the acceleration sensor 2 by a communication interface 211.

Furthermore, it is preferred that the MCU control module 21 controls the crystal oscillator module 2151 by a crystal oscillator interface 215.

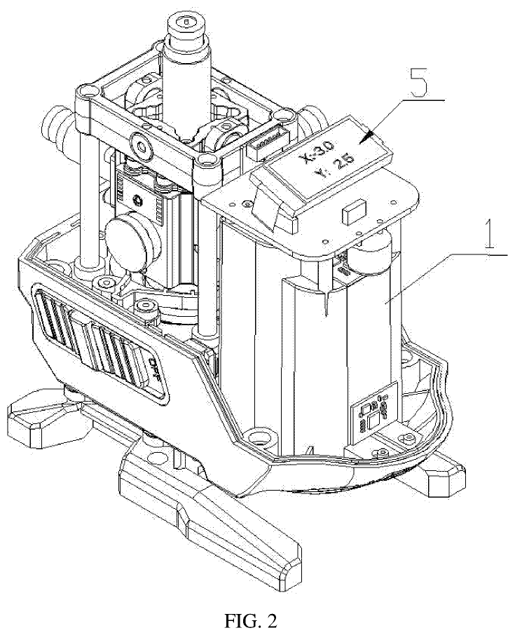

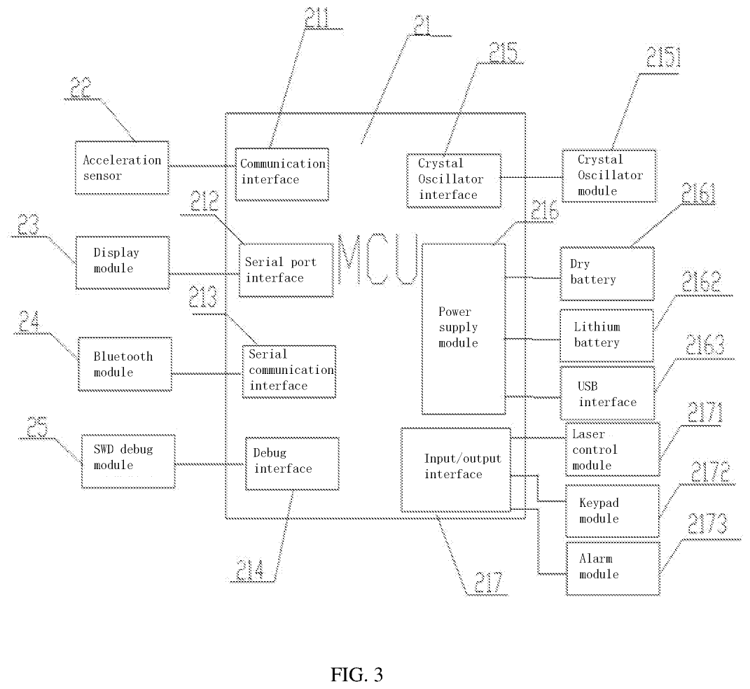

Referring to FIG. 2 and FIG. 3, in the illustrated embodiment, the MCU control module 21 is connected with a display module 23, the motherboard 2 is disposed with a display screen 5, and the display module 23 is configured for controlling the display screen 5 to display.

Preferably, the MCU control module 21 controls the display module 23 by a serial port interface 212.

The illustrated embodiment of the invention uses the acceleration sensor 22 to obtain data and provides the obtained data to the motherboard 2 for processing and feedbacking to the display screen 5 of the main body 1 to display a current angle value, and thereby achieve the purpose of measuring/detecting the angle; and at the same time, it can acquire the required angle position by cooperating with a line projected by the demarcation device onto a target object or wall, there is no need to use an inclinometer to assist. The projected line and angle display both are provided by the main body 1 of the invention, so no auxiliary coordination is required, and the data read by different users are consistent, and it will not cause reading error due to poor cooperation of users.

The invention combines the functions of demarcation apparatus and inclinometer, unifies the value reading standard, and the functions can be used simultaneously or separately, which can save the investment cost for consumers, and the mechanical standardized value reading can reduce unnecessary disputes in the process of measurement and acceptance.

In an embodiment, the MCU control module 21 is connected with a bluetooth module 24. The bluetooth module 24 is configured for receiving an operation command of a remote controller and sending a detection information to a mobile phone APP. Preferably, the MCU control module 21 controls the bluetooth module 24 by a serial communication interface 213.

The MCU control module 21 is connected with a debug module 25, and the debug module 25 is configured for debugging tilt data. Preferably, the debug module 25 includes a SWD (serial wire debug) debug module.

Furthermore, it is preferred that the MCU controls the debug module 25 by a debug interface 214.

The MCU control module 21 is connected with an alarm module 2173, and the alarm module 2173 is configured for alarming.

Moreover, it is preferred that the MCU control module 21 controls the alarm module 2173 by an input/output interface 217.

After the gyroscope pendulum assembly on the main body 1 of the invention is adjusted to be horizontal/leveled, the acceleration sensor 22 is set to zero. When acquiring an angle value exceeding 3°, the MCU control module 21 starts to send a signal to enable laser line to flash for alarm, and when the angle value recovers to be within 3°, the flash for alarm is stopped.

Compared with the prior art, the embodiment of the invention cancels a conductive circuit and a contact plate, reduces the production materials, reduces the installation process, and the chip angle is more sensitive and stable in the use process, does not need the complex hardware circuit, and reduces the risk that the circuit cannot work due to circuit damage in high temperature and high humidity environment.

A working principle of the invention is as follows:

1. the angle sensor chip (e.g., acceleration sensor chip) is fixed on the main body 1 in the horizontal direction, so that tilt angles of the angle sensor chip in the horizontal and vertical directions are consistent with that of the apparatus;

2. the acceleration sensor 22 can measure/detect components of its own relative gravity accelerations on the X/Y/Z axis, the MCU control module 21 reads register values of the acceleration sensor 22 through the communication interface 211 and then calculates the inclination/tilt angle value;

3. the MCU control module 21 communicates with the display screen (e.g., LCD display screen) through serial port interface 212, and displays the inclination/tilt angle value on the display screen 5 in real time, so that the user can view the tilt angle of the apparatus in real time. That is, the invention has the function of inclination/tilt angle measurement/detection;

4. the MCU control module 21 also has the function of real-time monitoring tilt state of apparatus, when the MCU control module 21 reads that the tilt angle exceeds a preset angle, controls the peripheral (laser module) to flash and the buzzer to sound for alarm.

In an illustrated embodiment, the MCU control module 21 may control the laser control module 2171 by the input/output interface 217. The laser control module 2171 controls the laser module 4. That is, the MCU control module 21 controls the laser module 4 by the laser control module 2171.

In an illustrated embodiment, the MCU control module 21 may receive an instruction from a keypad module 2172 by the input/output interface 217. The instruction can be inputted by the keypad module 2172 to control the MCU control module 21.

In another embodiment of the invention, the power supply module 216 includes: a boost charging module 2164, a lithium battery 2162, a first MOS (Metal-Oxide-Semiconductor) transistor 2165 and a boost power chip 2168. The boost charging module 2164 is used for charging the lithium battery 2162, and the lithium battery 2162 is used for supplying a power to the boost power chip 2168 by the first MOS transistor 2165.

The power supply module 216 further includes a dry battery 2161 and a second MOS transistor 2166. The dry battery 2161 is used for supplying a power to the boost power chip 2168 by the second MOS transistor 2166.

Preferably, the power supply module 216 further includes a third MOS transistor 2167 connected with the boost power chip 2168.

Moreover, it is preferred that the power supply module 216 further includes a step-down power chip 2169 connected with the input terminal of the boost charging module 2164 and the input terminal of the boost power chip 2168.

In an embodiment, the power supply module 216 may include the boost power chip 2168 or the step-down power chip 2169, so as to supply a power in a boosting manner or a stepping down manner.

The MCU control module 21 of the embodiment of the invention reads the gravitational acceleration values of X/Y/Z axis of the LIS3DH (which is 3-axis MEMS acceleration sensor) through I2C communication, to calculate tilt angles of the acceleration sensor chip with respect to horizontal and vertical directions.

Since the acceleration sensor chip is fixed on the apparatus in the horizontal direction, it ensures position consistency of title angle with that of the apparatus. The zero setting of the embodiment of invention is to place the apparatus on a horizontal surface to read the gravitational acceleration values of LIS3DH's X/Y/Z axis, calculate the angle value and save it. A difference of the subsequent reading value minus the saved value is used as the inclination/tilt angle of the apparatus. The zero setting eliminates an initial error to ensure accuracy.

The MCU control module 21 communicates with the display screen through SPI, displays the inclination/tilt angle on the display screen and refreshes the inclination angle in real time. At the same time, the battery power is collected by ADC (Analog-to-Digital Converter) and displayed in real time. When the value of the data collected and processed by the MCU control module 21 exceeds a preset angle, the MCU control module will give an alarm by controlling the peripheral (laser module) to flash.

The above are only preferred embodiments of the invention, and does not limit the patent protection scope of the invention. On the premise of not departing from the spirit and scope of the invention, the invention will have various modification and improvements. Under the inventive concept of the invention, equivalent structural transformations made by using the description and the attached drawings of the invention, or direct/indirect application in other related technical fields are all included in the scope of patent protection of the invention.

What is claimed is:

1. A laser demarcation apparatus with angle detection function, comprising a main body, wherein the main body is disposed with a pendulum body, and the pendulum body is disposed with a laser module; characterized in that:
the main body further is disposed with a motherboard, and the motherboard is disposed with a tilt detection device;
wherein the tilt detection device comprises a MCU control module, an acceleration sensor, a crystal oscillator module and a power supply module; the MCU control module is configured to control and analyze angle tilt information, the acceleration sensor is configured to detect a tilt angle to thereby generate the angle tilt information, the crystal oscillator module is configured to stabilize a control frequency of the MCU control module, and the power supply module is configured to supply a power;
wherein the MCU control module is configured to control the acceleration sensor and the crystal oscillator module individually.

2. The laser demarcation apparatus with angle detection function as claimed in claim 1, wherein the MCU control module is connected with a display module, the motherboard is disposed with a display screen, and the display module is configured to control the display screen to display.

3. The laser demarcation apparatus with angle detection function as claimed in claim 2, wherein the MCU control module is connected with a bluetooth module, and the bluetooth module is configured to transmit a detection information.

4. The laser demarcation apparatus with angle detection function as claimed in claim 3, wherein the MCU control module is connected with a debug module, and the debug module is configured to debug a tilt data.

5. The laser demarcation apparatus with angle detection function as claimed in claim 4, wherein the MCU control module is connected with an alarm module, and the alarm module is configured to alarm.

6. The laser demarcation apparatus with angle detection function as claimed in claim 1, wherein the power supply module comprises a boost charging module, a lithium battery, a first MOS transistor, and a boost power chip; the boost charging module is configured to charge the lithium battery, and the lithium battery is configured to supply a power to the boost power chip by the first MOS transistor.

7. The laser demarcation apparatus with angle detection function as claimed in claim 6, wherein the power supply module further comprises a dry battery, and a second MOS transistor; the dry battery is configured to supply a power to the boost power chip by the second MOS transistor.

8. The laser demarcation apparatus with angle detection function as claimed in claim 7, wherein the power supply module further comprises a step-down power chip.
